(19) United States
(12) Patent Application Publication
(10) Pub. No.: US 2010/0046691 A1
(43) Pub. Date: Feb. 25, 2010

(54) METHOD FOR DISMANTLING A CONTROL ELEMENT OF A BOILING WATER REACTOR

(75) Inventors: Wolfgang Hummel, Weisendorf (DE); Wolfgang Nahr, Erlangen (DE); Wolfgang Lucken, Hirschaid (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/604,756

(22) Filed: Oct. 23, 2009

Related U.S. Application Data
(63) Continuation of application No. 11/043,331, filed on Jan. 26, 2005.
Application No. 11/043,331 is a continuation of application No. PCT/EP2004/001721, filed on Feb. 21, 2004.

(30) Foreign Application Priority Data
Apr. 8, 2003 (DE) 103 16 248.8

(51) Int. Cl. G21C 19/00

(52) U.S. Cl. 376/260

(57) ABSTRACT

A method enables dismantling of a control element of a boiling water reactor. Two control element leaves that are disposed opposite one another are separated by means of a roll-cutting method from the other two control element leaves, respectively along an intersection line extending in the longitudinal direction thereof and in the vicinity of the longitudinal center axis.

### CROSS-REFERENCE TO RELATED APPLICATION

This is a continuation of application Ser. No. 11/043,331, filed Jan. 26, 2005, which was a continuation, under 35 U.S.C. §120, of copending international application No. PCT/EP2004/001721, filed Feb. 21, 2004, which designated the United States. This application also claims the priority, under 35 U.S.C. §119, of German patent application No. 103 16 248.8, filed Apr. 8, 2003. The prior applications are herewith incorporated by reference in their entirety.

### BACKGROUND OF THE INVENTION

### Field of the Invention

The invention relates to a method for dismantling a control element of a boiling water reactor (BWR).

When disposing of radioactively contaminated parts of a nuclear reactor, it is in many cases necessary for these parts to be dismantled in order to reduce the space required for final storage. This is carried out, for example, under water in fuel element cooling ponds or pools.

By way of example, it is known from German patent DE 29 42 406 C2 to use roll cutting blades to cut up the fuel assembly channel of a fuel element of a boiling water reactor in the axial direction along its corners, so that flat strips are formed. These are additionally cut up transversely with respect to their longitudinal direction in order to further reduce the space taken up during final storage.

One particular problem arises when dismantling a control element of a boiling water reactor, on account of the neutron absorbers which are present in the control element leaves. These are, depending on the design of the control element, for example, tubes filled with boron carbide BC₄ or absorber leaves made from hafnium Hf that should not be released into the pond water.

In this context, it is in principle known to separate the control element leaves from the solid cross-shaped core body consisting of steel by means of cuts made in the axial direction. The control element leaves which have been separated off can then be wound up into coils using a method known from German patent DE 197 00 651 C1 and U.S. Pat. No. 5,940,462 in order to be further compacted.

However, there are technical problems with detaching the control element leaves using axial cuts close to the crossing point. Therefore, in U.S. Pat. No. 5,055,236 it is proposed that the control elements be sawn into two halves in the axial direction along the center axis, these halves each comprising two control element leaves arranged at right angles to one another.

### BRIEF SUMMARY OF THE INVENTION

It is accordingly an object of the invention to provide a method and a corresponding device for dismantling a control element of a boiling water reactor which overcome the above-mentioned disadvantages of the heretofore-known devices and methods of this general type and which dismantling produces as little secondary waste as possible and the release of neutron absorber material is substantially avoided.

With the foregoing and other objects in view there is provided, in accordance with the invention, a method of dismantling a control element of a boiling water reactor, the method which comprises:

providing a control element having a longitudinal center axis defining a longitudinal direction, and control element leaves including two first control element leaves disposed opposite one another relative to the longitudinal center axis and two second control element leaves disposed opposite one another relative to the longitudinal center axis;

separating the first control element leaves from the second control element leaves with a roll-cutting process and thereby cutting along a cutting line extending in the longitudinal direction and in a vicinity of the longitudinal center axis.

In other words, the first above-mentioned object is achieved, according to the invention, by a method in which two control element leaves located opposite one another are in each case separated from the other two control elements in a roll cutting process. The leaves are separated along a cut line which extends in the longitudinal direction and is arranged in the vicinity of the longitudinal axis, i.e., the parting or cutting line runs within the cross-shaped core body of the control element, damage to the regions which contain the neutron absorber material and therefore release of the neutron absorber material are reliably avoided. Since, moreover, a rolling cutting method is used for cutting, the formation of further secondary waste, as would occur, for example, in the form of cutting chips during a milling operation, is also avoided in practice.

After the two control element leaves have been detached, they can be placed onto the control element leaves which have not been detached, so that space-saving compacting is possible with the speed limiter removed.

In an advantageous configuration of the invention, the roll cut is in each case performed on the two flat sides of the control element leaf using oppositely inclined roll cutters. This halves the cut depth required for each roll cutter and means that the pressure forces required for cutting are reduced.

With the above and other objects in view there is also provided, in accordance with the invention, a device for performing the above-outlined method. That is, a device is provided for dismantling a control element of a boiling water reactor, the device comprising:

a guide for receiving the control element for movement, in relative terms, in the axial direction; and

a cutting unit with at least two cutting rolls which can each be placed onto the flat sides of two of the control element leaves located opposite one another.

In accordance with an added feature of the invention, the cutting unit has four cutting rolls disposed opposite one another in pairs.

In accordance with an additional feature of the invention, the cutting rolls are hydraulically or electromechanically actuated cutting rolls.

In accordance with again an additional feature of the invention, the cutting unit is supported on a frame that surrounds the control element in a working position.

In accordance with a concomitant feature of the invention, four guide rolls are directed onto the longitudinal center axis for guidance on both sides of the cutting unit.

Other features which are considered as characteristic for the invention are set forth in the appended claims.

Although the invention is illustrated and described herein as embodied in a method for dismantling a control element of a boiling water reactor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic overall illustration of a device according to the invention;

FIG. 2 is a diagrammatic cross sectional view of a control element, with cutting rolls of the device according to the invention placed onto it; and

FIG. 3 is a diagrammatic cross sectional view through the control element with guide rolls of the device according to the invention bearing against it.

### DETAILED DESCRIPTION OF THE INVENTION

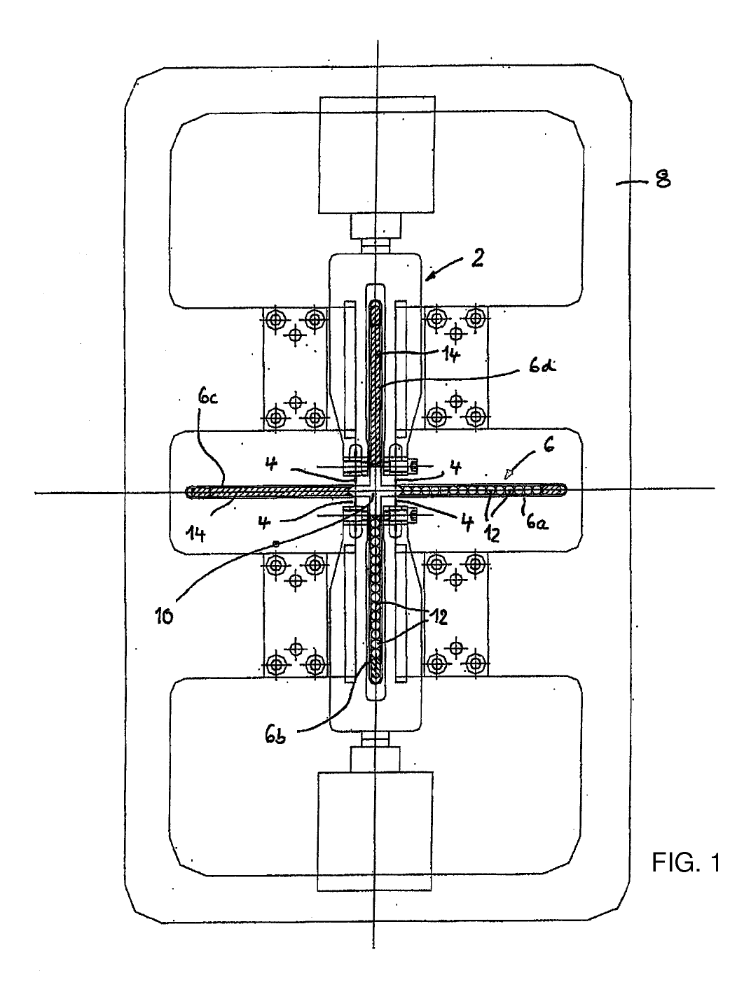

Referring now to the figures of the drawing in detail and first, particularly, to FIG. 1 thereof, there is shown a device according to the invention that includes a cutting unit 2 with four cutting rolls 4, which in the working position are each placed in pairs onto oppositely located control element leaves 6a, 6c of a control element 6. The cutting unit 2 is disposed in a frame 8 which surrounds the control element 6 and continuously absorbs the application forces that occur during the cutting operation. The relative movement of the control element 6 and cutting unit 2 in the direction of the longitudinal center axis of the control element 6 takes place either through movement of the control element 6 with the cutting unit 2 stationary, for example by way of a lifting mechanism, or by displacement of the entire device along the stationary control element 2.

The control element 6 includes four control element leaves 6a-6d which are arranged in a cross shape, originate from a cross-shape, solid core body 10 and in the cavities of which there are disposed neutron absorbers, for example absorber tubes 12 filled with boron carbide BC₄ (illustrated for the control element leaves 6a, b) or in an alternative configuration absorber leaves 14 made from hafnium Hf (illustrated for the control element leaves 6c, d).

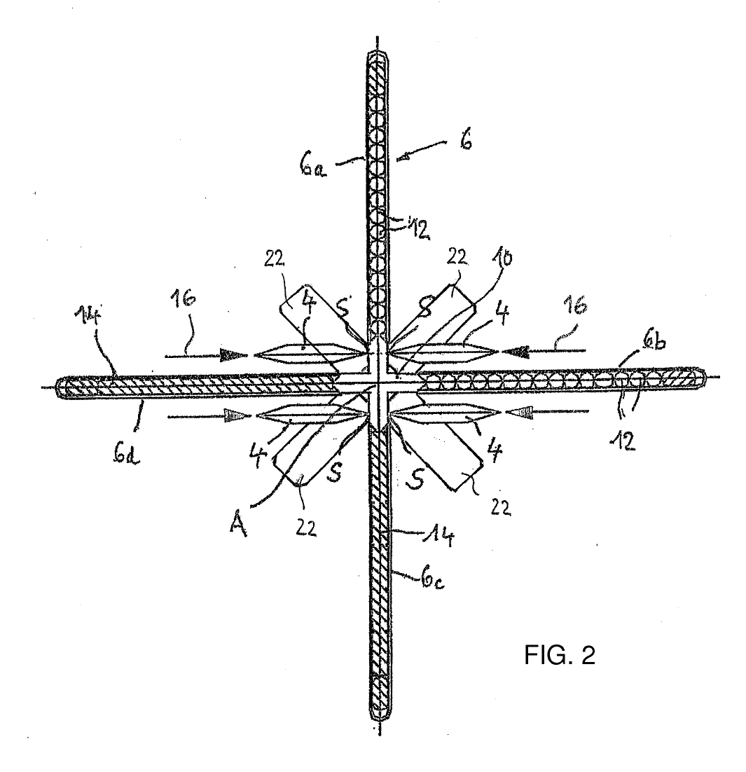

FIG. 2 provides a clearer illustration of the way in which the device functions. The cutting rolls 4, in the region of the core body 10, are placed onto the flat sides of the control element leaves 6a and 6c, in each case in pairs, and are then moved toward one another in the direction indicated by the arrows 16. An advancing motion perpendicular to a longitudinal center axis A executes a rolling cut along a cutting line S. The cutting line S extends in the longitudinal direction, i.e. perpendicular to the plane of the drawing and parallel to the longitudinal center axis A, in the vicinity of the crossing point or in the vicinity of the longitudinal center axis A.

The advancing movements of the two opposite cutting rolls 4 are limited in such a way that it is just no longer possible for their lead cutting edges to touch one another. The advancing movement of the cutting rolls 4 perpendicular to the flat sides of the control element leaves 6a, 6c which are in each case to be detached is carried out using hydraulic cylinders in the exemplary embodiment. In particular, the force with which the cutting rolls 4 are advanced is controllable, so that despite the different material properties of the control element 6 as a function of the axial cutting position, a virtually constant cutting rate can be achieved over the entire length of the control element leaves 6a, 6c. A further alternative to advancing the cutting rolls 4 by force by means of hydraulic cylinders is to use an electromechanical feed unit, which allows a feed travel to be predetermined per partial cutting operation, with simultaneous force monitoring.

Since two cutting rolls 4 act with an approximately equal compressive force on each separating location, the required separation depth is reduced in half, and the approximately equal displacement of material from the two sides of the control element leaf substantially avoids bending.

As an alternative to the paired arrangement of cutting rolls 4 illustrated in the figure, it is also possible to provide only a single cutting roll 4 for each of the two control leaves 6a, 6c that are to be detached, and this cutting roll 4 is in each case assigned a mating roll without any cutting edges which is placed onto the surface of the control element leaf 6a or 6c as a counter-roller.

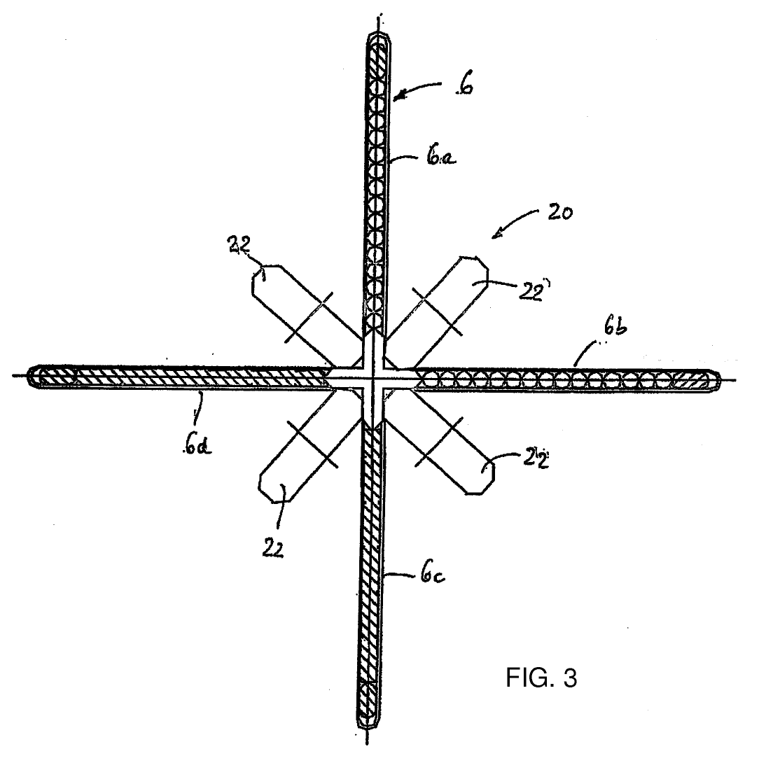

To allow reliable guidance of the control element 6 and/or the cutting unit, a guide 20, which in each case comprises four guide rolls 22 oriented diagonally onto the longitudinal center axis A, is provided on both sides of the cutting unit shown in FIG. 3, as seen in the longitudinal direction of the control element 2.

1. A method of dismantling a control element of a boiling water reactor, the method which comprises:
providing a control element having a longitudinal center axis defining a longitudinal direction, a cross-shaped solid core body and control element leaves disposed in a cross shape, originating from the solid core body and having mutually-opposite substantially flat sides, the control element leaves including two first control element leaves disposed opposite one another relative to said longitudinal center axis and two second control element leaves disposed opposite one another relative to said longitudinal center axis;
moving the control element and a guide relative to each other in axial direction;
providing a cutting unit with at least two cutting rolls;
placing one of the cutting rolls onto one of the mutually-opposite substantially flat sides of one of the control element leaves in vicinity of the solid core body, and placing another of the cutting rolls onto one of the mutually-opposite substantially flat sides of another of the control element leaves disposed opposite to the one of the control leaves, relative to the longitudinal center axis; and
separating the first control element leaves from the second control element leaves with the cutting unit in a roll-cutting process and thereby cutting along a cutting line extending in the longitudinal direction and in a vicinity of the longitudinal center axis.

2. The method according to claim 1, which comprises forming a roll cut on each of two flat sides of each said first control element leaf using oppositely inclined cutting rolls.
